(19) United States
(12) Patent Application Publication
(10) Pub. No.: US 2026/0071434 A1
(43) Pub. Date: Mar. 12, 2026

(54) EPDM ROOFING MEMBRANES REINFORCED WITH SHORT FIBER ARAMIDS

(71) Applicant: CARLISLE CONSTRUCTION MATERIALS, LLC, Carlisle, PA (US)

(72) Inventor: Majid KARIMI NEJAD, Carlisle, PA (US)

(73) Assignee: CARLISLE CONSTRUCTION MATERIALS, LLC, Carlisle, PA (US)

(21) Appl. No.: 19/311,470

(22) Filed: Aug. 27, 2025

Related U.S. Application Data
(60) Provisional application No. 63/692,566, filed on Sep. 9, 2024.

(51) Int. Cl. E04D 12/00; C08K 7/02; C08L 9/00

(52) U.S. Cl. CPC E04D 12/002; C08K 7/02; C08L 9/00; C08L 2207/04

(57) ABSTRACT

An EPDM roofing membrane with improved hail resistance formed from a block of EPDM material with short aramid fibers added to the block of EPDM material at a concentration of 5 to 35 PHR, a weak alkaline accelerator added to the block of EPDM material at a concentration of 2 to 8 PHR, a thermoplastic elastomer added to the block of EPDM material at a concentration of 2 to 10 PHR, polysulfide silane added to the block of EPDM material at a concentration of 2 to 10 PHR; and a hemiaminal ether crosslinking agent added to the block of EPDM material at a concentration of 2 to 10 PHR.

### RELATED APPLICATION

The present application claims priority to U.S. Provisional Patent Application Ser. No. 63/692,566, of same title, filed Sep. 9, 2024, the entire disclosure of which is incorporated herein by reference in its entirety for all purposes.

### TECHNICAL FIELD

The present invention relates to improved EPDM roofing membranes.

### BACKGROUND OF THE INVENTION

Factory Mutual's 4470's procedure for Very Severe Hail Testing is a new test standard that has had a significant impact on the construction of commercial roof systems in fourteen states throughout the Midwest. Many roofing systems are unable to achieve the Very Severe Hail rating due to various modes of failures. Because of this new test, there is a desire in the industry to improve the hail impact resistance of various roofing systems.

Unfortunately, one of the limitations of standard EPDM roofing membranes is that they often do not stand up very well to severe hail. As a result, they tend to fail Factory Mutual's Very Severe Hail Test. One technique that has been used to reinforce standard EPDM roofing membranes is to use a polyester fleece backing. Unfortunately, simply adding a fleece backside to the EPDM membrane introduces manufacturing complexity and thus increases its costs. It would instead be desirable to reinforce the EPDM roofing membrane in a different manner without having to use a fleece backing. As will be shown, the present system provides such EPDM membrane reinforcement system that enables the roofing membrane to pass the Very Severe Hail test.

### DESCRIPTION OF THE INVENTION

In accordance with the present invention, short fiber aramids are used to reinforce the EPDM membrane. One advantage of adding short fiber aramids directly to the EPDM material is that these short fibers can easily be mixed together with other normal additives in normal manufacturing processes. Therefore, additional preparation or manufacturing steps or equipment are not required. The specific advantages of mixing short fiber aramids (and the various other compounds described below) into the EPDM roofing membrane include improving its tear resistance and improving the hardness and stiffness of the roofing membrane. This makes the present EPDM roofing membrane more resistant to hail, and thereby able to pass Factory Mutual's Very Severe Hail Test.

In accordance with the present system, the EPDM membrane is reinforced both by adding desired concentrations of the short fiber aramids and by adding desired concentrations of four other compounds. Both the aramids and the four other compounds described below are added in specific ranges to achieve the desired effect of reinforcing the EPDM roofing membrane such that it can withstand Factory Mutual's Very Severe Hail Test.

First, the short aramid fibers were added in preferred ranges between 5 and 35 PHR. Note: the amount of additives to be added is expressed in parts per hundred resin/rubber, i.e.: “PHR”. PHR provides the weight of additives per 100 units of the base rubber. In the two experimental results presented below in Table 1, the short aramid fibers were added at 20 PHR. Both of these experimental samples passed the Very Severe Hail Test. Although 20 PHR was an ideal value for these experiments, it is to be understood that the present invention encompasses a preferred range of 5 to 35 PHR for such short aramid fibers.

Second, a weak alkaline accelerator for slow vulcanization of natural- and synthetic rubbers such as “HEXA-80” was added. An exemplary HEXA-80 material is Rhenogran® made by RheinChemie Additives. Preferably, this accelerator is added in preferred ranges between 2 and 8 PHR. In the two experimental results presented in Table 1, the HEXA-80 was added at 4 PHR. Both of these experimental samples passed the Very Severe Hail Test. Although 4 PHR was an ideal value for these experiments, it is to be understood that the present invention encompasses a preferred range of 2 to 8 PHR for such weak alkaline accelerators as HEXA-80.

Third, a thermoplastic elastomer such as MAH-G-EPDM (ethylene-propylene-diene-monomer grafted maleic anhydride) is added. Preferably, this elastomer is added in preferred ranges between 2 and 10 PHR. An exemplary MAH-G-EPDM used in the present tests is FUSABOND™ N302, made by Dow Chemical. In the two experimental results presented in Table 1, the MAH-G-EPDM was added at 5 PHR. Both of these experimental samples passed the Very Severe Hail Test. Although 5 PHR was an ideal value for these experiments, it is to be understood that the present invention encompasses a preferred range of 2 to 10 PHR for such weak alkaline accelerators.

Fourth, polysulfide silane such as S169 SILANE is added. Primary SS 169 polysulfide silane is a bifunctional additive that enhances the performance of a variety of organic rubber formulations. An exemplary polysulfide silane used in the present tests is STRUKTOL® SCA 98 made by Struktol Company of America. Preferably, it is added in preferred ranges between 2 and 10 PHR. In the two experimental samples presented in Table 1, the polysulfide silane was added at 5 PHR. Both of these experimental samples passed the VSH Test. Although 5 PHR is an ideal value for these experiments, it is to be understood that the present invention encompasses a preferred range of 2 to 10 PHR polysulfide silane concentrations.

Fifth, a hemiaminal ether crosslinking agent such as hexa(methoxymethyl)melamine (HMMM) is added. (HMMM-50% was added in the present experiments). An exemplary HMMM is COHEDUR® also made by RheinChemie Additives. Preferably, it is added in preferred ranges between 2 and 10 PHR. In the two experimental samples presented in Table 1, the HMMM was added at 4 PHR. Both of these experimental samples passed the VSH Test. Although 4 PHR is an ideal value for these experiments, it is to be understood that the present invention encompasses a preferred range of 2 to 10 PHR of HMMM.

TABLE 1
Experimental Results

| | | | |
|---|---|---|---|
| Sample # | Control | Trial -1 | Trial-2 |

Formulas

| | | | |
|---|---|---|---|
| EPDM | 100 | 100 | 100 |
| Mg (OH)2 | 43 | 43 | |
| Talc | 20 | 20 | 20 |
| Dixie Clay - Bulk | 98 | 78 | 121 |
| Black N-330 Carbon Black | 67 | 67 | 67 |
| Process Oil | 76 | 76 | 76 |
| Processing Aid | 2 | 2 | 2 |
| STEARITE | 1 | 1 | 1 |
| Zinc Oxide HTR | 3 | 3 | 3 |
| Aramide Short Fiber 50% | | 20 | 20 |
| HEXA-80 | | 4 | 4 |
| MAH-G-EPDM | | 5 | 5 |
| SI69 (Silane) | | 5 | 5 |
| TBBS | 1.08 | | |
| MBTS | 1 | | |
| TMTD | 0.47 | | |
| HMMM-50% | | 4 | 4 |
| Sulfur | 1.08 | | |
| Total (Phr) | 413.10 | 427.48 | 427.10 |

Properties

| | | | |
|---|---|---|---|
| Hardness (Shore A) | 68 | 86 | 86 |
| Tear Resistance (Psi)- MD/CD | 223/221 | 254/240 | 273/270 |
| Specific Gravity | 1.235 | 1.199 | 1.199 |
| SVH FM | Fail | Pass | Pass |

What is claimed is:

1. An EPDM roofing membrane, comprising:
a block of EPDM material;
short aramid fibers added to the block of EPDM material at a concentration of 5 to 35 PHR;
a weak alkaline accelerator added to the block of EPDM material at a concentration of 2 to 8 PHR;
a thermoplastic elastomer added to the block of EPDM material at a concentration of 2 to 10 PHR;
polysulfide silane added to the block of EPDM material at a concentration of 2 to 10 PHR; and
a hemiaminal ether crosslinking agent added to the block of EPDM material at a concentration of 2 to 10 PHR.

2. The EPDM roofing membrane of claim 1, wherein the a weak alkaline accelerator is HEXA-80.

3. The EPDM roofing membrane of claim 1, wherein the thermoplastic elastomer is MAH-G-EPDM.

4. The EPDM roofing membrane of claim 1, wherein the hemiaminal ether crosslinking agent such is HMMM.
